(19) United States
(12) Patent Application Publication
(10) Pub. No.: US 2022/0083929 A1
(43) Pub. Date: Mar. 17, 2022

(54) DOCUMENTED WORKFLOWS

(71) Applicant: Hewlett-Packard Development Company, L.P., Spring, TX (US)

(72) Inventors: Helen Balinsky, Bristol (GB); Josep Abad Peiro, Sant Cugat del Valles (ES)

(73) Assignee: Hewlett-Packard Development Company, L.P., Spring, TX (US)

(21) Appl. No.: 17/420,056

(22) PCT Filed: Jan. 9, 2019
(86) PCT No.: PCT/US2019/012917

§ 371 Date: Jun. 30, 2021

(51) Int. Cl. G06Q 10/06

(52) U.S. Cl. CPC G06Q 10/0633

(57) ABSTRACT

In an example there is provided a method to specify a workflow template comprising a sequence of tasks to be performed by workers to execute a workflow, encode the workflow template into a secure ledger, receive a transaction request from a worker to perform a task of the workflow according to the workflow template and validate the transaction request according to the content of the secure ledger.

### BACKGROUND

Workflows are ubiquitous in business environments. Workflows comprise a sequence of orchestrated and repeatable patterns of business activities. Workflows allow businesses to systematically organize resources and processes. Systemizing business processes through workflows allow businesses to streamline processes. Tracking of tasks and auditing of workflows may involve maintaining a detailed record of the workflow tasks and execution of operations of the workflow.

### BRIEF DESCRIPTION OF THE DRAWINGS

FIG. 1 shows an apparatus for implementing a workflow, according to an example.

FIG. 2 shows a block diagram of a method for use with a secure ledger, according to an example.

FIG. 3 shows a processor associated with a memory and comprising instructions validating workflow transactions on a computing device, according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

In recent years, secure ledger or “blockchain” technology has become increasingly prevalent. Secure ledgers can be used in a diverse range of contexts to provide guarantees that certain processes have properly been executed and that tasks have been carried out according to a well-defined process. Secure ledgers implement cryptographic hash functions to ensure the integrity of a process or data represented in the ledger.

A secure ledger may be implemented as follows: the output of a record of an earlier transaction in the ledger is hashed and is used as an input to the next block in a chain. Further data may be input into the next block such as a record that a further transaction has occurred. This creates a secure-by-design process where the integrity of any point of the chain can be verified by recomputingf hash values on inputs and checking the recomputed hash values against the ledger. In some cases it is sufficient to check the final output against the last recorded item on the ledger based on the inputs.

Another common feature of secure ledger technology is that the ledger may be stored in a decentralized fashion. For example, the ledger can be stored across a peer-to-peer network where nodes hold their own copy of the ledger and can collectively verify the authenticity of alleged transactions by recomputing ledger data.

Using secure ledgers, it is possible to execute whole protocols and maintain a verifiable record of each step of the protocol. For example, Bitcoin and other cryptocurrencies implement a ledger which provides a secure and verifiable transaction history. The transaction history can be verified by anyone at a later point in time.

Ledger technology digitizes and simplifies many processes which would previously have required trusted third-party verification to perform securely. Secure ledgers provide a higher degree of certainty for participants and provide greater security over trusted third-party models. For this reason, secure ledgers have become increasingly important technology in businesses in the 21^{st} century and will continue to have an impact over the coming decades.

In business contexts a workflow is defined as a sequence of workflow tasks, which may be executed in a pre-defined order by workers to accomplish the workflow. Methods and systems described herein map individual workflow tasks into a set of transactions in a workflow template. The workflow template is encoded into a secure ledger.

Each individual transaction from a real workflow instance references the corresponding workflow template transaction in the secure ledger. Once the set of transactions is defined, the order of execution of the tasks can also be defined. In some cases, the workflow order of execution may be a linear sequence. In other, more complex workflows the order of execution comprises a complex graph.

The order of execution of the tasks is also encoded into the secure ledger prior to workflow instantiation. Once the execution order is defined, the workflow can be executed. Each new transaction in the real workflow is checked against the corresponding workflow template in the secure ledger, as well as being in the correct order of execution according to the corresponding workflow order encoded into the secure ledger. The secure ledger provides an immutable history of all workflow transaction requests. This can be used, for example, in an auditing process

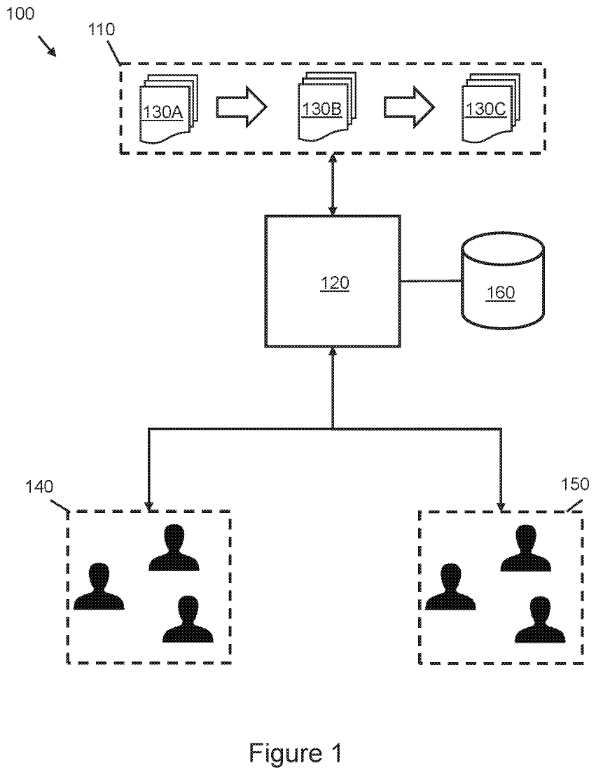

FIG. 1 shows an apparatus 100 for managing a workflow according to an example. In FIG. 1 there is shown a workflow 110 and a workflow controller 120. The workflow 110 comprises a sequence of workflow tasks 130A, 130B, 130C. In the example of the workflow 110 shown in FIG. 1, the workflow tasks 130 are completed in a linear sequence.

The workflow controller 120 is arranged to manage the workflow 110 in a computing environment. This may include, for example, maintaining a view of the workflow 110 on the computing system that the workflow controller 120 is implemented on. According to examples, the workflow controller is implemented as either a hardware component, or as a software component in a computer readable medium.

According to examples, the workflow controller 120 is arranged to determine when tasks 130 have been completed and manage the different stages of the workflow 110. The workflow controller 120 is also arranged to maintain an order of execution of the workflow tasks 130 according to an execution graph. Workflow tasks 130 may be referenced using identifiers maintained by the workflow controller 120.

In the present context a “worker” may be an actual human operator or a software or hardware component which is involved in a workflow. In other cases a worker may comprise a team of individuals or programs working together in a workflow. In FIG. 1 there are shown two groups of workers 140, 150 which are in communication with the workflow controller 120. The workers 140, 150 may be users within the same or different organizations.

The apparatus 100 shown in FIG. 1 further comprises a secure ledger 160. Herein a “secure ledger” is a data structure comprising a sequence of blocks of data. Each block references and is derived from at least one of the previous blocks in the sequence. In addition, each block may comprise additional data corresponding to additional inputs. According to examples described herein the workflow controller 120 is arranged to encode the workflow 110 in the secure ledger 160. The secure ledger 160 comprises a record of all workflow related transactions. This includes a record of the creation of the workflow 110, and any further transactions such as the assignment of workflow tasks to workers by the workflow controller 120.

According to examples described herein the workflow controller 120 is arranged to compute an initial entry on the secure ledger 160 as a function of an input associated to a creation of the workflow 110. For example, an initial entry on the secure ledger may comprise a hash value of a reference to a particular workflow template. The workflow controller is further arranged to compute a subsequent entry to the secure ledger 160 as a function of at least the previous entry on the secure ledger 160. In some examples, a subsequent entry to the secure ledger 160 is computed as a function of further additional inputs, for example, identifiers and/or public keys of workflow task owners or workers.

The secure ledger 160 comprises a trackable and auditable ledger of every workflow-related transaction. The function of the input may be computed using, for example a secure cryptographic hash function. According to examples a secure ledger may be implemented as a blockchain or a hash chain. Subsequent workflow-related transactions may be recorded to the secure ledger 160 as a function of previous entries on the secure ledger 160 and new inputs such as worker identifiers, workflow task-related identifiers etc. For example, a first workflow related transaction may comprise a creation of a workflow according to a workflow template. This is recorded in the secure ledger by hashing a reference value. Subsequent entries to the secure ledger 160 may comprise hash values of references to completion of workflow related tasks and the previous entry recorded on the secure ledger 160.

According to examples described herein the secure ledger 160 may be implemented and stored in a database. In other examples, the secure ledger 160 may be stored in a decentralised fashion. For example, the secure ledger may be stored across a peer-to-peer network where individual nodes of a network each possess a copy of the secure ledger and update the secure ledger accordingly in response to instructions from the workflow controller 120.

According to examples, the workflow controller is arranged to process transaction requests from the workers 140, 150 which execute the workflow 110 according to the workflow template. In some examples, the workflow controller 120 is arranged to process workflow transaction requests by receiving a transaction request from a worker 140, 150 and validating the transaction request on the basis of the content of the secure ledger 160. This may comprise recomputing values stored in the secure ledger on alleged inputs to check the validity of the workflow request and payload of the request.

In examples described herein, the workflow controller 120 is also arranged to check the transaction request corresponds to a task which is the next in sequence in the execution order of the workflow. In one case, this comprises checking that the task corresponds to the next task following the previously executed task. In another example, the workflow controller 120 may be arranged to authorize a worker and check that a worker is qualified to perform a workflow task.

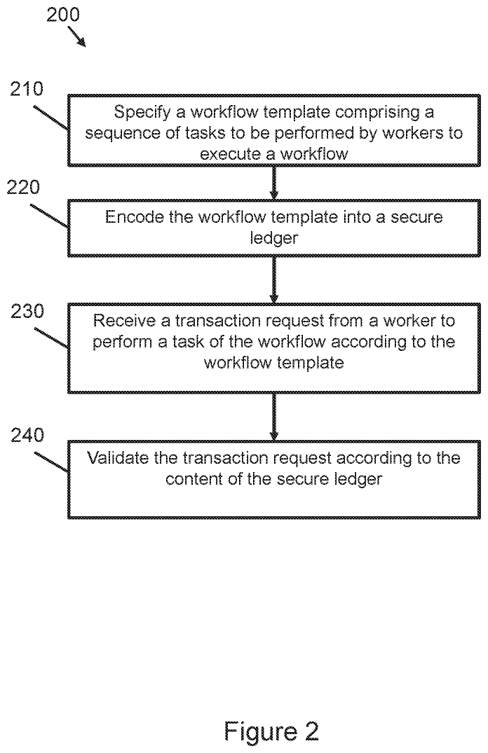

FIG. 2 shows block diagram of a method 200 for executing a workflow according to an example. The method 200 may be implemented by the workflow controller 120 and secure ledger 160 shown in FIG. 1. At block 210, a workflow template comprising a sequence of tasks to be performed by workers to execute a workflow is specified. The specification comprises a definition of tasks of the workflow and an execution order of the tasks required to perform the workflow.

At block 220, the workflow template for the workflow such as workflow 110 is recorded into a secure ledger such as the secure ledger 160 shown in FIG. 1. At block 230, a transaction request is received from a worker to perform a task of the workflow according to the workflow template. At block 240 the transaction request is validated according to the content of the secure ledger.

In certain examples described herein the transaction request is digitally signed by the worker. In some cases, digitally signing by the worker may be carried using a private key of a worker. In particular, in certain examples, a public/private key infrastructure is implemented between the workers 140, 150 executing tasks in a workflow, and the workflow controller 120 and secure ledger 160. According to methods and systems described herein, validating the transaction request from a worker involves validating the signature using a worker's public key.

According to examples described herein, validating the transaction request comprises determining that the task in the transaction request is the next stage of the workflow according to the workflow template, based on the content of the secure ledger. Validating the transaction request may further comprise validating the transaction request payload according to the workflow template.

In the examples of the method 200 described herein, the workflow controller 120 is arranged to reject the request if it is determined that the transaction request is invalid according to the secure ledger. A rejected transaction request may be reported back to the workers 140, 150 or to an external entity in some cases.

The methods and systems described herein can be used to support a workflow. The methods provide a way to produce a fully trackable workflow transaction history using a secure ledger. In contrast, other methods do not leave an immutable and verifiable record of workflow related transactions. The methods and systems described herein produce a fully auditable secure-by-design record which can be referred to and checked at a later date, for example, by a workflow administrator. The use of a secure ledger provides a particularly convenient method of creating such an auditable record and is efficient to implement in both centralised and decentralised systems.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

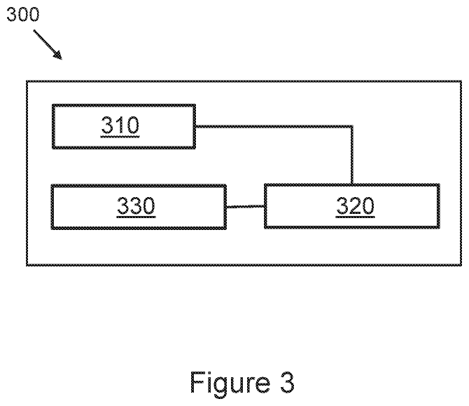

FIG. 3 shows an example of a processor 310 associated with a memory 320. The memory 320 comprises computer readable instructions 330 which are executable by the processor 310. The instructions 330 comprise instruction to, define a workflow template process comprising an order of execution of a workflow tasks to execute a workflow, record the workflow template process into a secure ledger, receive a request to perform execute a workflow task according to the workflow template; and verify the transaction request according to the content of the secure ledger.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
specifying a workflow template comprising a sequence of tasks to be performed by workers to execute a workflow;
encoding the workflow template into a secure ledger;
receiving a transaction request from a worker to perform a task of the workflow according to the workflow template; and
validating the transaction request according to the content of the secure ledger.

2. The method of claim 1, wherein the transaction request is digitally signed by the worker.

3. The method of claim 2, wherein digitally signing the transaction request is performed with a workers' private key.

4. The method of claim 3, wherein validating the transaction request comprises validating the signature using a workers' public key.

5. The method of claim 1, wherein validating the transaction request comprises determining that the task in the transaction request is the next stage of the workflow according to the workflow template, based on the content of the secure ledger.

6. The method of claim 1, wherein validating the transaction request comprises validating the transaction request payload according to the workflow template.

7. The method of claim 1, comprising rejecting a transaction request in response to determining that the request is invalid according to the content of the secure ledger.

8. The method of claim 1, wherein encoding the workflow template to a secure ledger comprises:
computing an initial entry to the secure ledger as a function of an input associated to the creation of the workflow.

9. The method of claim 8, wherein encoding the workflow template to the secure ledger comprises:
computing a subsequent entry to the secure ledger as a function of at least the previous entry on the secure ledger.

10. An apparatus comprising:
a workflow controller arranged to manage a workflow according to a workflow template;
a secure ledger comprising a record of workflow related transactions;
wherein the workflow controller is arranged to:
encode a workflow template into the secure ledger; and
process transaction requests workers executing the workflow according to the workflow template.

11. The apparatus of claim 10, wherein the workflow controller is arranged to:
receive a transaction request to perform a workflow task from a worker; and
validate the transaction request on the basis of the content of the secure ledger.

12. The apparatus of claim 10, wherein the workflow controller is arranged to compute a function of an input associated to the creation of the workflow to encode the workflow template into the secure ledger.

13. The apparatus of claim 12, wherein the workflow controller is arranged to compute a subsequent entry to the secure ledger as a function of at least the previous entry on the secure ledger.

14. A non-transitory machine-readable storage medium encoded with instructions executable by a processor, to:
define a workflow process comprising an order of execution of a workflow tasks to execute a workflow;
record the workflow process into a secure ledger;
receive a request to execute a workflow task according to the workflow; and
verify the request according to the content of the secure ledger.
